(19) United States
(12) Patent Application Publication
(10) Pub. No.: US 2005/0206344 A1
(43) Pub. Date: Sep. 22, 2005

(54) Method for recharging a battery at the same time it is being used as a power source

(76) Inventor: Earl Grant SR., Chicago, IL (US)

Correspondence Address: Earl Grant SR., 6723 So. OGlesby, Chicago, IL, 60649, US

(21) Appl. No.: 11/066,080

(22) Filed: Feb. 25, 2005

Related U.S. Application Data
(60) Provisional application No. 60/550,957, filed on Mar. 4, 2004.

(51) Int. Cl. H02J 7/00

(52) U.S. Cl. 320/128

(57) ABSTRACT

A method for recharging a battery, at the same time it is being used as a power source, by using a portion of the electrical output to operate an alternator to produce low current and low voltage electrical power to recharge the battery.

### CROSS-REFERENCE TO RELATED APPLICATIONS

Provisional Application No. 60/550,957

### STATEMENT REGARDING FEDERALLY SPONSORED RESEARCH OR DEVELOPMENT

Not Applicable

### REFERENCE TO SEQUENCE LISTING, A TABLE, OR A COMPUTER DISK APPENDIX

Not Applicable

### BACKGROUND OF THE INVENTION

There are many situations in which users of electrical tools, lights, radios, appliances, equipment and other electrically-powered items are unable to connect to a regular source of electrical power. Batteries are used to provide electrical power in such situations either directly to the equipment being used or to a portable generator to which the equipment is connected. However, a battery is not entirely satisfactory as a power source in such situations because it must be frequently recharged.

Relevant U.S. patents are identified below:

| | | |
|---|---|---|
| 5689174 | November, 1997 | Pacheco |
| Re31156 | February, 1983 | Dessert |
| 1275201 | August, 1918 | Beach |
| 2813984 | November, 1957 | Dolecki, et al. |
| 3719881 | March, 1973 | Shibata, et al. |
| 4042056 | August, 1997 | Horwinski |
| 4438342 | March, 1984 | Kenyon |
| 4470476 | September, 1984 | Hunt |
| 4604565 | August, 1986 | Yokopta, et al. |
| 4951769 | August, 1990 | Kawamura |
| 5497070 | March, 1996 | Furutani, et al. |

### BRIEF SUMMARY OF THE INVENTION

The invention addresses the need to recharge a battery by using a portion of the electrical output, at the same time the battery is being used as a power source, to operate an alternator to produce low current and low wattage electrical power to recharge the battery.

### BRIEF DESCRIPTION OF THE SEVERAL VIEWS OF THE DRAWING

FIG. 1 System diagram showing DC battery, inverter, load, AC motor, alternator and return to DC battery

FIG. 2 System diagram as in FIG. 1, with additional detail regarding power output, voltage regulator, fan motor and mechanical connections.

FIG. 3 System diagram showing required apparatus enclosed within a frame.

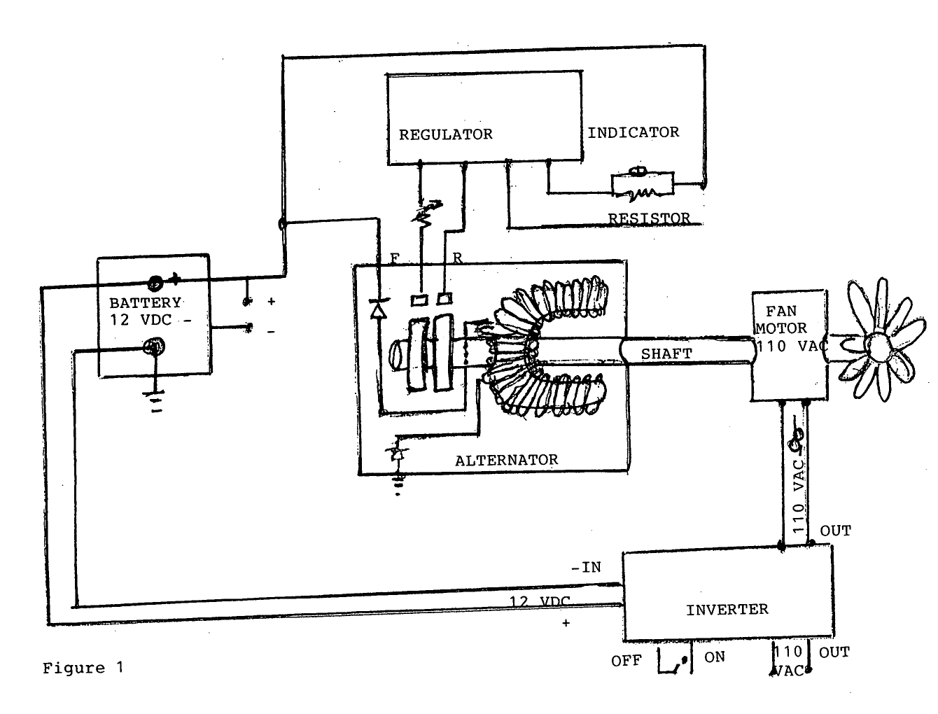

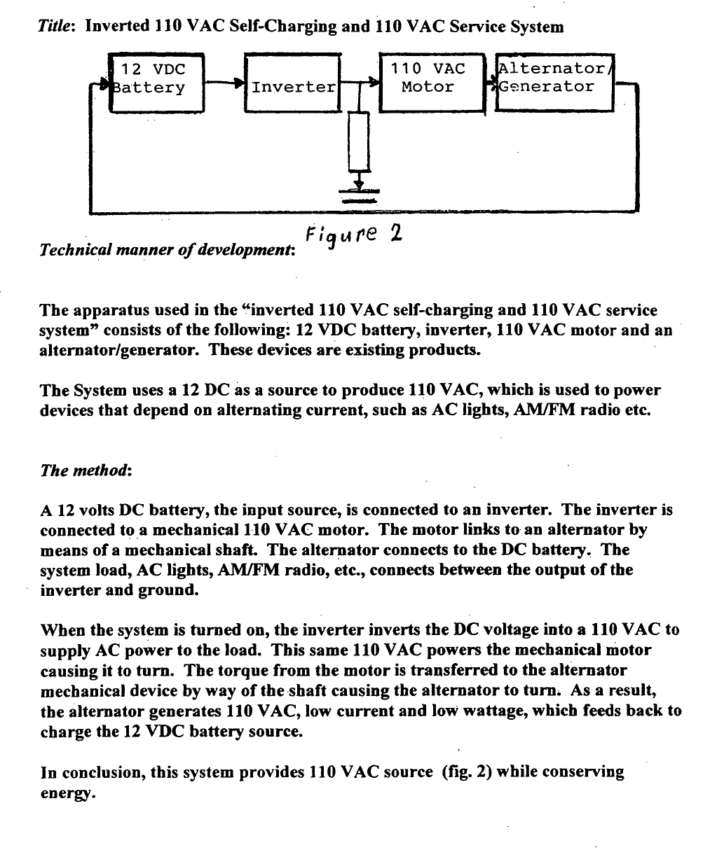

### DETAILED DESCRIPTION OF THE INVENTION

A DC battery, the input source, is connected to an inverter. The inverter is connected to an AC mechanical motor. The motor is linked to an alternator by means of a mechanical shaft. The alternator connects to the DC battery. The system load, e.g. a power tool, connects to the system between the electrical output of the inverter and ground.

When the system is activated, the inverter converts DC power from the battery to supply AC power to the load and, at the same time, to the mechanical motor causing it to turn. The torque from the motor is transferred to the alternator by way of the shaft, causing the alternator to turn and to generate low current which feeds back to recharge the battery.

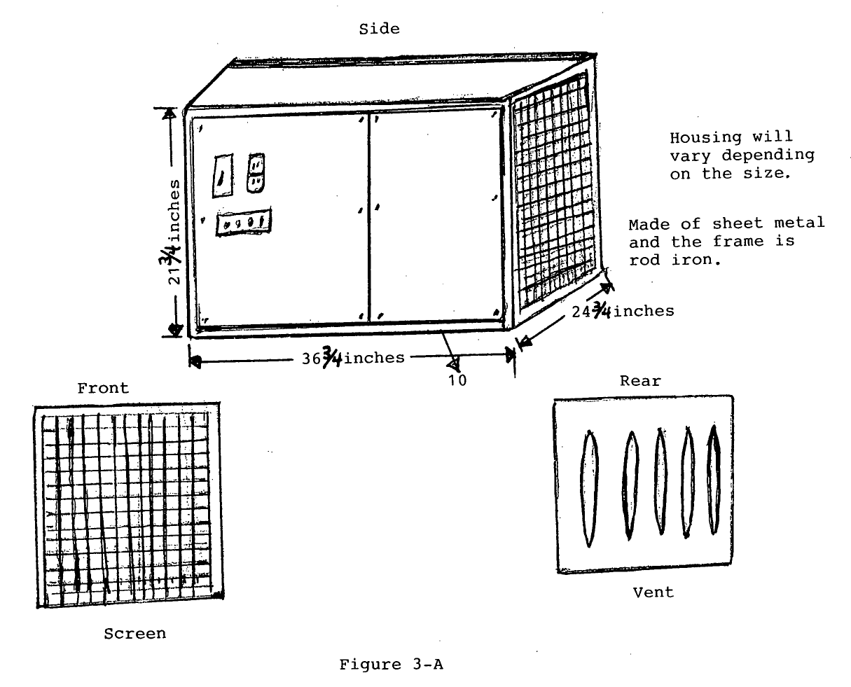

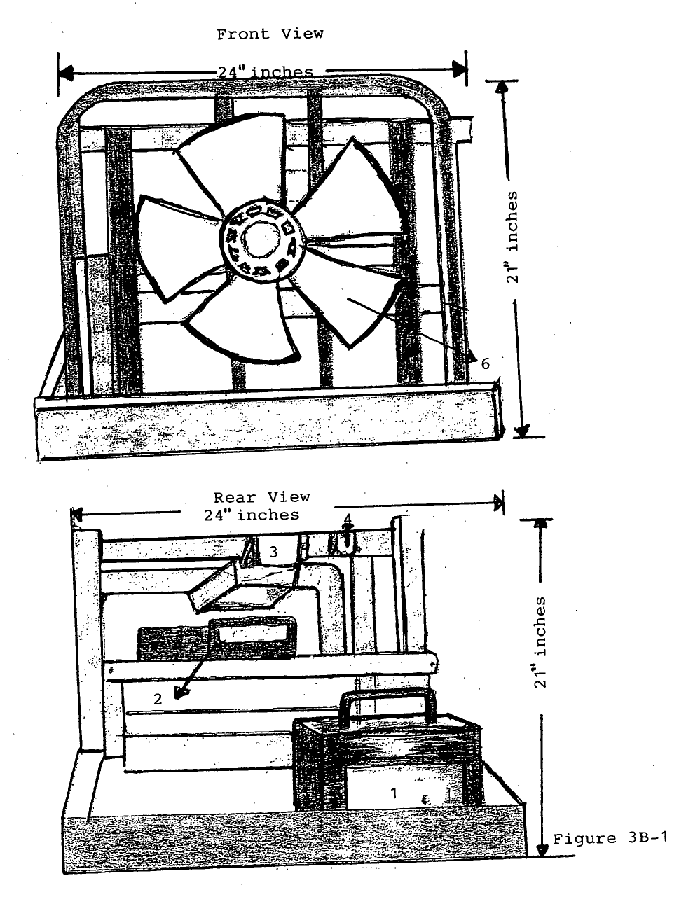

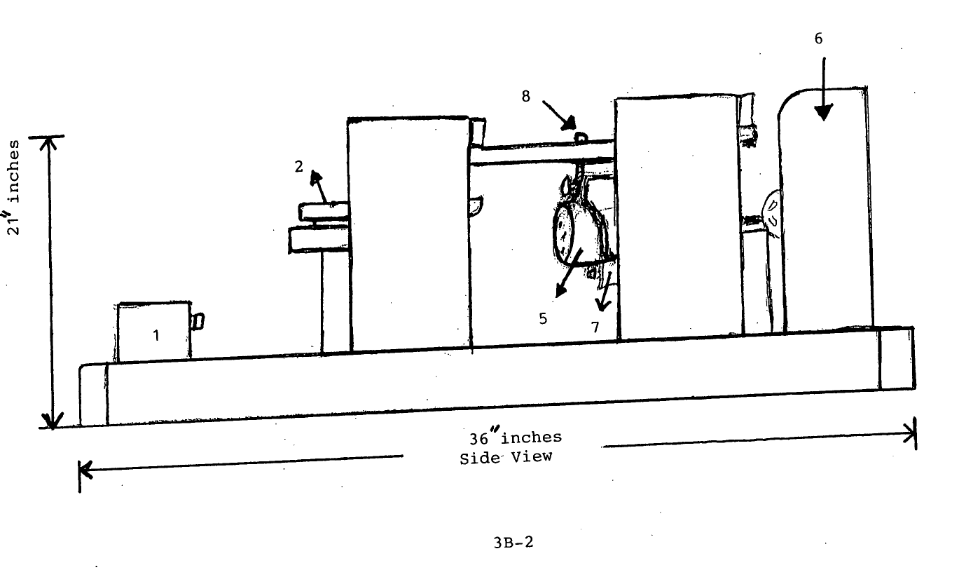

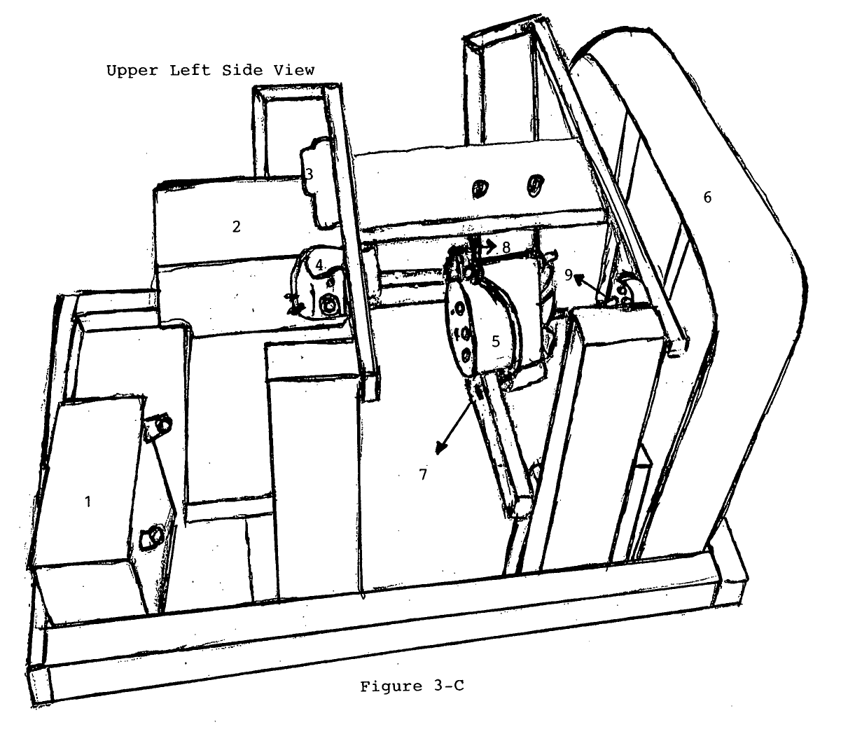

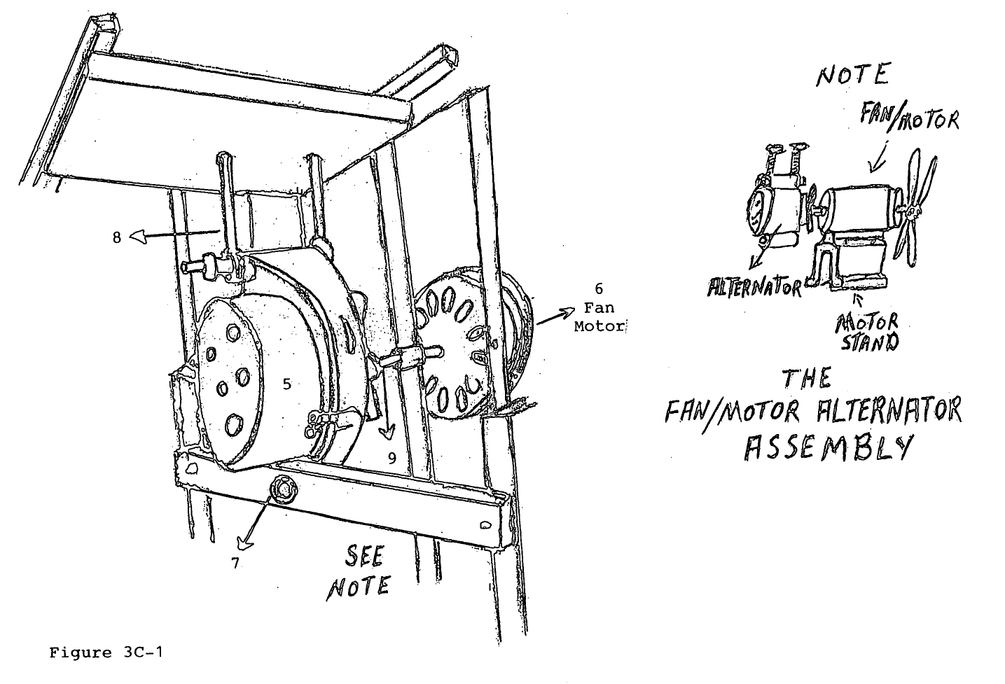

Aside from the system assembly shown in FIG. 3, all of the components and mechanical apparatus are available commercially. The method of connecting and employing these components and apparatus is new.

### PARTS LIST BY NUMBER FOR FIG. 3

1. Battery
2. Inverter
3. Regulator
4. Switch (high current)
5. Alternator
6. 6. Fan/Motor (reverse flow fan)
7. Stabilizing bar and adjustment screw
8. Mounting screw
9. Shaft for connecting motor and alternator
10. Housing

1. A method for recharging a battery, at the same time it is being used as a power source, by using electrical power from the battery for that purpose.

2. A method for recharging a DC battery, at the same time it is being used as a power source, by using a portion of the electrical power from the battery for that purpose.

3. A method for recharging a DC battery, at the same time it is being used as a power source, by using a portion of the electrical power from the battery to generate AC electrical power and to use the AC power for that purpose.

4. A method for recharging a DC battery, at the same time it is being used as a power source, by converting its output to AC power and using the AC power to operate an alternator to produce low current and low wattage AC power, and to use the AC power for that purpose.

5. A method for recharging a DC battery, at the same time it is being used as a power source, by converting its output to AC power, using a portion of the AC power first to handle the system load and next to operate an alternator to produce low current and low wattage AC power, and to use the AC power for that purpose by connecting the alternator to the DC battery.
